(19) United States
(12) Patent Application Publication
(10) Pub. No.: US 2026/0339143 A1
(43) Pub. Date: Oct. 29, 2026

(54) MOBILE ROBOT WITH CONTROLLABLE FILM

(71) Applicant: Bear Robotics, Inc., Redwood City, CA (US)

(72) Inventor: Louis Maurice Plottel, Waban, MA (US)

(21) Appl. No.: 19/119,655

(22) PCT Filed: Oct. 11, 2023
(86) PCT No.: PCT/US2023/076538

§ 371 Date: Apr. 9, 2025

Related U.S. Application Data
(60) Provisional application No. 63/379,061, filed on Oct. 11, 2022.

(51) Int. Cl. G02F 1/1334; B25J 5/00; B25J 9/00; B25J 11/00; G06F 21/31

(52) U.S. Cl. CPC G02F 1/1334; B25J 5/007; B25J 9/0009; B25J 11/008; G06F 21/31

(57) ABSTRACT

A method including obscuring a viewing window into a container of a mobile robot by placing a polymer dispersed liquid crystal (PDLC) film in a first, non-energized state. A direct current (DC) waveform from a battery can be converted to a periodic current waveform. The periodic current waveform can be directed through at least one conductive layer of the PDLC film to transition the PDLC film to a second, energized state that renders the viewing window into the container of the mobile robot at least partially transparent.

### CROSS-REFERENCE TO RELATED APPLICATIONS

This application claims the benefit of the filing date of U.S. Patent Application No. 63/379,061 filed on Oct. 11, 2022, the disclosure of which is hereby incorporated by reference in its entirety.

### TECHNICAL FIELD

The disclosed subject matter relates generally to the technical field of mobile robots and delivery systems and, in one specific example, to a solution for a selectively transparent window of a mobile robot.

### BACKGROUND

A mobile delivery robot can be used to deliver small items or parcels in a variety of situations. Examples include delivering items to small or isolated areas, such as a garage or a home in a rural area, delivering small items to the top floor of an office building, delivering meals in nursing homes, transporting dirty instruments or disposable items in hospitals, delivering meals or assisting in cleaning at a restaurant, and delivering packages in hotels and apartment buildings. Such robots can move in a variety of ways, for example, moving along fixed or immobile paths or paths along which the robot can move by self-power (e.g., by wheels, tracks, etc.) or by the power of an electric motor. Some delivery robots can provide navigation assistance to the robot.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various examples discussed in the present document.

FIG. 1 depicts a mobile robot, according to some examples.

FIG. 2 is a block diagram that describes a mobile robot, according to some examples.

FIG. 3 is a diagrammatic representation of an environment in which multiple mobile robots are deployed to respective locations, according to some examples.

FIG. 4 is a block diagram illustrating one view of components and modules of the mobile robot of FIG. 1, according to some examples.

FIG. 5 is a block diagram illustrating another view of components and modules of the mobile robot of FIG. 1, according to some examples.

FIG. 6 is a block diagram showing a machine learning model system for use with the robot of FIG. 1, according to some examples.

FIG. 7 is a diagrammatic representation of a machine, according to some examples.

FIG. 8 is a block diagram illustrating a software architecture, according to some examples.

FIG. 9 is a block diagram showing a machine-learning program, according to some examples.

FIG. 10 is a diagrammatic representation of a processing environment, according to some examples.

FIG. 11 is a flowchart that describes a method for operating a mobile robot, according to some examples.

### DETAILED DESCRIPTION

During mobile delivery of an item by a mobile delivery robot, one or more items can be enclosed within a chamber of the robot during transit or until verification of an intended recipient. In one approach to such mobile delivery, an opaque door or window can be provided to close the chamber. Here, the opaque door can conceal contents enclosed within a chamber of a mobile robot and can allow the mobile robot to present contents to an intended recipient only if the intended recipient is present within the intended delivery area. For example, the opaque door can open such as to visually present the enclosed item to one or more potential recipients. A problem with this approach is that the item must also be physically presented for removal to the one or more potential recipients if it is to be visually presented. As such, an intended recipient must first be verified before being visually presented with the enclosed item, or the enclosed item must be physically presented for removal to the one or more potential recipients before the intended recipient is verified. This can lead to unintended delivery of the enclosed item to an unverified recipient. Also, this approach presents the difficulty that even if an intended recipient is correctly verified, this verified intended recipient cannot confirm the correct item (via visual identification) before being presented with the item.

In another approach, the door or window can be transparent such as to allow for constant visual presentation of the enclosed item, allowing physical presentation only upon verification of an intended recipient. A problem with this approach occurs when the chamber includes one or more sensitive or unsightly items, e.g., currency, valuables, dirty medical instruments, dirty dishes, etc. Thus, there remains a need for a technique that allows for selective viewing of contents within a chamber of a mobile delivery robot irrespective of whether such contents are being physically presented for removal to one or more potential recipients.

The present inventor has conceived of a method including a selectively transparent viewing window for visually presenting an item in the enclosed chamber without needing to physically present the item for removal. For example, the method can include obscuring the viewing window using a polymer dispersed liquid crystal (PDLC) film in a first, non-energized state. A waveform modulator can be used such as to convert a direct current (DC) waveform from a battery onboard the mobile delivery robot to periodic current waveform. For example, the periodic current waveform can include a pulsating direct current (PDC), an alternating current (AC) waveform, a square-wave current, or a sine-wave current. The periodic current waveform can be used to create an electric field which can be used to temporarily align molecules or crystals of the PDLC film. For example, this periodic current waveform can be directed through at least one conductive layer of the PDLC film to transition the PDLC film to a second, energized state that renders the viewing window at least partially transparent.

The method can include authenticating, upon transition of the PDLC film to the second, energized state, an identity of a recipient of the deliverable item. In some examples, the method can include opening a door of the mobile delivery robot to permit access to the receptacle to the authenticated recipient. Also, authenticating can include receiving, via a user interface of the mobile delivery robot, an access code.

The method can also include transmitting the access code to an intended recipient user account. The method can include determining that the mobile delivery robot is located within a specified radius of an intended destination. Also, the viewing window can be rendered at least partially transparent based on determining, for example using location circuitry, that the mobile delivery robot is within the specified radius of the intended destination.

The method can include determining an intended destination for delivery of the deliverable item. The deliverable item can be carried to the intended destination such as via a drive train of the mobile delivery robot. In some examples, displaying of contents inside the mobile delivery robot can be performed upon the mobile delivery robot arriving at the intended destination.

Also disclosed is a mobile delivery robot including a container to enclose a deliverable item within the container of the mobile delivery robot. The mobile delivery robot can include or use a viewing window to provide a view into the container, the viewing window including a polymer dispersed liquid crystal (PDLC) film actuatable to transition between a first, non-energized state and a second, energized state. For example, in the first, non-energized state the viewing window is at least partially opaque or translucent to light in the visible spectrum. In the second, energized state, the viewing window is at least partially transparent or more translucent than in the first non-energized state.

The mobile delivery robot can include or use a waveform modulator to convert a direct current (DC) waveform from a battery onboard the mobile robot to a periodic current (e.g., pulsating direct current (PDC) or alternating current (AC) waveform. In some examples, the mobile delivery robot can include or use an actuator to direct the periodic current waveform through at least one conductive layer of the PDLC film to alter the PDLC film to the second, energized state.

Each of the non-limiting examples described herein can stand on its own or can be combined in various permutations or combinations with one or more of the other examples.

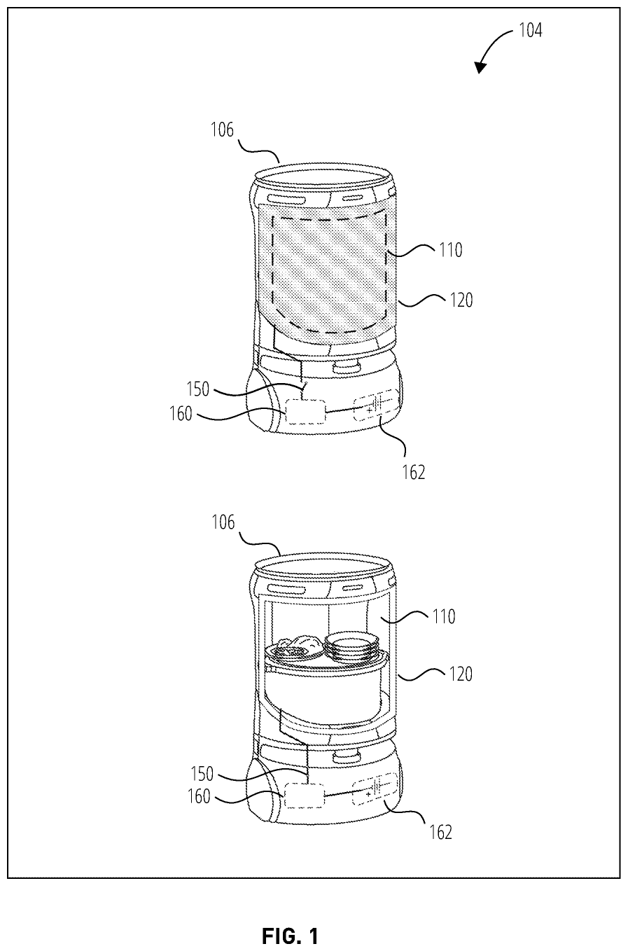

FIG. 1 depicts a mobile robot 104, according to some examples. The mobile robot 104 includes a housing 106 that accommodates various components and modules, including a power train system including wheels that enable the mobile robot 104 to propel itself within a service location. The mobile robot 104 can include one or more containers 110 to enclose a deliverable item within a container of the mobile robot 104, and a viewing window 120 to provide a view into the container. The viewing window 120 can be operable between a first, non-energized state (as seen in the top panel in FIG. 1) and a second, energized state (as seen in the bottom panel in FIG. 1). In some examples, the viewing window 120 can include a polymer dispersed liquid crystal (PDLC) film. The PDLC film can be substantially opaque to light in the first, non-energized state and optically transparent to light when the viewing window 120 is in the second, energized state. For example, the PDLC film can include liquid crystals immersed in a substrate with different alignment directions. For example, the liquid crystals have a planar alignment along the same plane but different tilt angles. By applying a voltage, the liquid crystals can be switched between a first alignment direction and a second alignment direction. When the light passes through the liquid crystal film with the first alignment direction, the light is substantially scattered when the light reaches the viewing window 120. As the light is scattered by the liquid crystals, the light is blocked by the viewing window 120. When the light passes through the liquid crystal film with the second alignment direction, crystals in the liquid crystal film are aligned, allowing the light to pass therethrough and without substantially scattering the light. When a voltage is applied to the PDLC film, the PDLC film can be switched between an opaque state and a transparent state in a controllable manner. In some examples film includes a conductive layer having a thickness between about 50 micrometers (μm) and about 200 μm. Thus, the viewing window 120 can be formed within a single layer of the PDLC film or one or more additional layers.

While the operation of the viewing window 120 is generally discussed herein with respect to a PDLC film, other materials can be similarly used to obscure or display the viewing window. For example, the viewing window can include other types of liquid crystal films such as polymer dispersed cholesteric liquid crystal (PDCL) or polymer network liquid crystal (PNLC) films. Additionally, the viewing window can include other materials such as, for example, electrochromic materials and liquid crystal on silicon (LCOS) materials. Additionally, the viewing window can include other materials such as, for example, polymer on silicon (POS) materials.

The mobile robot 104 can include or use a waveform modulator 160 to convert a direct current (DC) waveform from a battery 162 onboard the mobile robot 104 to a periodic current waveform. For example, the periodic current waveform can be a pulsating direct current (PDC) produced by an oscillator included in the waveform modulator 160. Also, the periodic current waveform can be an alternating current (AC) waveform produced by an inverter included in the waveform modulator 160. The mobile robot 104 can also include an actuator 150 to direct the periodic current waveform through at least one conductive layer of the PDLC film to alter the PDLC film to the second, energized state. For example, the actuator 150 can include or use a micro-electromechanical system (MEMS) array can be disposed within the housing 106. The MEMS array can include at least one MEMS device switch, such as a cantilevered metal spring, that is coupled to at least one piezoelectric (PZT) actuator. Thus, when the mobile robot 104 is energized, the MEMS device switches can switch corresponding PZT actuators in the MEMS array between an electrically conducting state and a non-conducting state.

In some examples, the PDLC film can include or use a first protective layer, a first conductive layer, a liquid crystal matrix, a second conductive layer and a second protective layer. When a voltage is applied to the first and second conductive layers, the first and second conductive layers act as a capacitor, causing the liquid crystals in the liquid crystal matrix to align with the electric field produced by the first and second conductive layers. The first and second conductive layers can be coupled to the battery through the waveform modulator 160 and/or an actuator 150. Thus, when the mobile robot 104 is energized, the first and second conductive layers of the PDLC film can be switched such as to cause a corresponding actuator 150 to alter the PDLC film to the second, energized state B.

As compared with mechanically opening and closing a door each time the enclosed item must be presented to a potential recipient, selectively displaying the item applying the voltage to the at least one conductive layer of the PDLC film can help save energy. This can be important in mobile robot power handling since a mobile robot must continually recharge batteries to make its way to different locations. For example, mechanically opening a door can require an energy expenditure of about 0.005 Watt-hours (Wh) per display instance, whereas energizing the PDLC film for about 10 seconds only requires an energy expenditure of about 0.003 Wh.

In another example, the viewing window 120 can include or use at least one display, such as a light emitting diode (LED) display, an organic light emitting diode (OLED) display, an electroluminescent display, a liquid crystal display (LCD), an organic light emitting transistor display, or an electron-conductive layer. Here, the at least one display can be at least partially transparent when a backlight of the display is not illuminating and opaque when the backlight of the display is illuminating. The display may be configured such that the entire display is transparent, or it may be configured to only cover the portion of the display that is not intended to be opaque. In another example, the viewing window 120 can include or use an actuatable curtain or blind. For example, the curtain can be actuated such as to obscure the viewing window 120 without presenting contents located therein for removal.

The mobile robot 104 can also include multiple sensors, including exteroceptive sensors, for capturing information regarding an environment or location within which a mobile robot 104 can be operating, and proprioceptive sensors for capturing information related to the mobile robot 104 itself. Examples of exteroceptive sensors include vision sensors (e.g., two-dimensional (2D), three-dimensional (3D), depth and RGB cameras), light sensors, sound sensors (e.g., microphones or ultrasonic sensors), proximity sensors (e.g., infrared (IR) transceiver, ultrasound sensor, photoresistor), tactile sensors, temperature sensors, navigation, and positioning sensors (e.g., Global Positioning System (GPS) sensor). Visual odometry and visual-SLAM (simultaneous localization and mapping) can assist a mobile robot 104 navigate in both indoor and outdoor environments where lighting conditions are reasonable and can be maintained. 3D cameras, depth, and stereo vision cameras provide pose (e.g., position and orientation) information. Examples of proprioceptive sensors include inertial sensors (e.g., tilt and acceleration), accelerometers, gyroscopes, magnetometers, compasses, wheel encoders, and temperature sensors. Inertial Measurement Units (IMUs) within a mobile robot 104 can include multiple accelerometers and gyroscopes, as well as magnetometers and barometers. Instantaneous pose (e.g., position and orientation) of the mobile robot 104, velocity (linear, angular), acceleration (linear, angular), and other parameters can be obtained through IMUs.

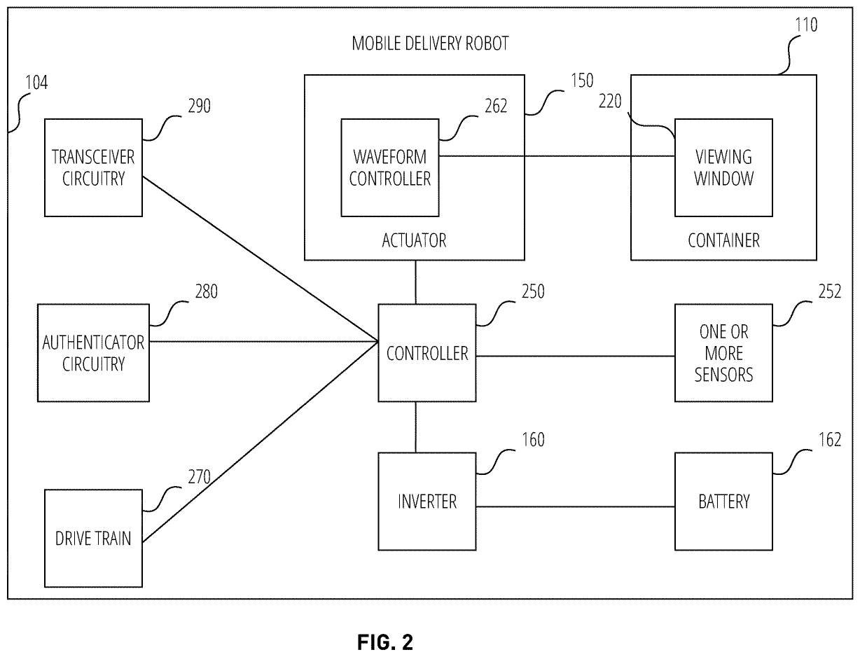

FIG. 2 is a block diagram that describes a mobile robot 104, according to some examples. The mobile robot 104 can include a drive train 270 that propels the mobile robot 104 to a desired location. The drive train 270 can include an electric motor, a plurality of gears and a plurality of wheels coupled to the electric motor. The plurality of gears can transmit the motion of the electric motor to the plurality of wheels. The plurality of wheels can provide traction to the mobile robot 104 to traverse the environment. The mobile robot 104 can also include a controller 250 that receives user input, interprets the input, computes a suitable control strategy, and outputs appropriate control signals to operate the electric motor and the plurality of wheels. The controller 250 can include a central processing unit (CPU) that controls the operation of the robot 104. The CPU can comprise a plurality of processing elements that are used to perform operations, and one or more memory modules that store information. A microprocessor can be a processing element in the CPU. The microprocessor can be a microcontroller, or a microprocessor having the capability to emulate a microcontroller. Additionally, the CPU can comprise a digital signal processor (DSP). Further, the CPU can include or be implemented in a real-time operating system (RTOS), which is a specialized operating system that provides real-time and multitasking capabilities for computer systems having limited memory and/or computational resources.

The mobile robot 104 can include one or more on-board sensors 252. The sensors 252 can include, e.g., a proximity sensor, a thermal imager, an acoustic sensor, a camera, or an image sensor. For example, a proximity sensor included in the one or more sensors 252 can detect the presence of objects and provide the detected object as an input to the mobile robot 104. Additionally, the proximity sensor can provide the user with an indication of the proximity of the mobile robot 104 to one or more objects in the environment. The proximity sensor can also be coupled to the CPU to provide the sensed proximity as an input to the CPU. The one or more on-board sensors 252 can provide the mobile robot 104 with a distance to the object in order to aid in navigation of the robot. Further, at least one on-board sensor 252 can provide a temperature of an item enclosed in the container 110. Further, at least one on-board sensor 252 can determine the type of item enclosed in the container 110.

The mobile robot 104 can also include or use transceiver circuitry 290 to receive coordinates corresponding to an intended destination for delivery of a deliverable item. For example, the transceiver circuitry 290 can be or include a radio frequency identification (RFID) reader. The transceiver circuitry 290 can communicate the coordinates to the mobile robot 104 and can further include one or more RFID tags. Also, the transceiver circuitry 290 can include or use a navigation system (e.g., a global positioning system (GPS) sensor, a gyroscope, a linear accelerometer, a compass, an odometer) to navigate within a geographic location, and a sensor to capture data corresponding to of a geographic location and estimate a coordinate reference system (e.g., a coordinate reference system with X, Y, Z axis). The estimated coordinate reference system can correspond to or align with a previously captured geographic coordinate reference system.

In some examples, the transceiver circuitry can receive instructions from a user or an automated robotic coordination system including an intended destination for delivery of the deliverable item. The transceiver circuitry can then communicate the intended destination of the delivery to the one or more sensors 252 of the mobile robot 104. The mobile robot 104 can then move to the intended destination by following a path from a location that corresponds to a currently determined geographic coordinate reference system. The mobile robot 104 can use a navigation algorithm to determine an expected path based on instructions from the user or the automated robotic coordination system, which can be programmed into the controller 250. For example, instructions from the user or the automated robotic coordination system can specify a direction in which to move and speed of travel. The instructions can further specify an expected time to arrival at the delivery location. The time to arrival can be computed by a vehicle navigation algorithm. Additionally, the automated robotic coordination system can further determine a location along a route that is at or closest to the delivery location. For example, the instructions can be generated or computed by a robotic steering algorithm, which can determine the direction in which to travel and the speed of travel along the route.

The actuator 150 can include a waveform controller 262 communicatively coupled to location circuitry to direct a periodic current waveform through the at least one conductive layer of the PDLC film upon mobile delivery robot arriving at the intended destination. The waveform controller 262 is operable to adjust the frequency and intensity of the periodic waveform signal to regulate the amount of energy delivered to the PDLC film from the battery 162. The frequency can be reduced as the mobile delivery robot nears the desired destination. The periodic current waveform can be an alternating current (AC) waveform produced by an inverter (e.g., a component of a waveform modulator as described in FIG. 1).

When the mobile delivery robot arrives at the intended destination, the waveform controller 262 can direct the periodic waveform signal toward the PDLC film through the at least one conductive layer of the PDLC film. Upon delivery of the desired dosage of energy, such as PDC energy or AC energy, the waveform controller 262 can adjust the frequency of the periodic current waveform to reduce the likelihood of electric shock or other adverse consequences.

The mobile robot 104 can also include authenticator circuitry 280 to identify an intended recipient, or a user account associated with the intended recipient, of the deliverable item. For example, the authenticator circuitry 280 can be or include a transponder (e.g., RFID tag). In some examples, the authenticator circuitry 280 can provide a signal to a transceiver circuitry 290 upon the recipient picking up the item. Also, the authenticator circuitry can be communicatively coupled to an authentication system. For example, the authentication system can generate or receive an authentication code and the authenticator circuitry can provide the authentication code to the intended recipient. After receiving the authentication code, the recipient can present the authentication code in order to verify that the delivery is authorized. For example, the authentication system can store a database that includes the codes used for the recipient of the delivery. In this example, the authenticator circuitry 280 can transmit the authentication code to the database (e.g., the authenticator circuitry 280 can act as a query). In this example, the recipient can use the received authentication code to retrieve the authentication code in the database. In some examples, the authenticator circuitry 280 can be communicatively coupled to a user interface to receive an access code. In some examples, robot 104 can include transceiver circuitry 290 for transmitting the access code to an intended recipient user account.

In another example, the user account associated with the intended recipient is associated with an internet protocol (IP) address (e.g., IP phone, IP camera, etc.). The authenticator circuitry 280 can be communicatively coupled to a mobile phone network of the user to receive the IP address. In this example, the IP address can be provided in response to a request by the mobile robot 104 to access a web page associated with the IP address.

In another example, the user account associated with the intended recipient is associated with a device connected to a network. For example, the authenticator circuitry 280 can be communicatively coupled to a device that is connected to a network (e.g., a wireless device (WLD) connected to a cellular network, a wireless local area network (WLAN), a wired local area network (LAN), etc.). The authenticator circuitry 280 can receive the IP address associated with the user account of the wireless device. Here, the wireless device can include a user interface that allows a recipient of the IP address to access the web page associated with the IP address. For example, the user interface can be a touch-screen display. In another example, the web page can be a web page that includes the IP address, the username of the recipient and a corresponding password to authenticate the recipient.

The controller 250 can operate one or more functions conditionally upon authentication of the intended recipient via the authenticator circuitry 280. For example, the controller 250 can be communicatively coupled with an openable door or window of the mobile robot 104 to physically present an enclosed item to an intended recipient upon successful authentication of the intended recipient. Also, the controller 250 can selectively operate the viewing window 220 (e.g., corresponding to viewing window 120 in description of FIG. 1) to visually present an enclosed item, via applying the voltage to the PDLC film, upon successful authentication of the intended recipient.

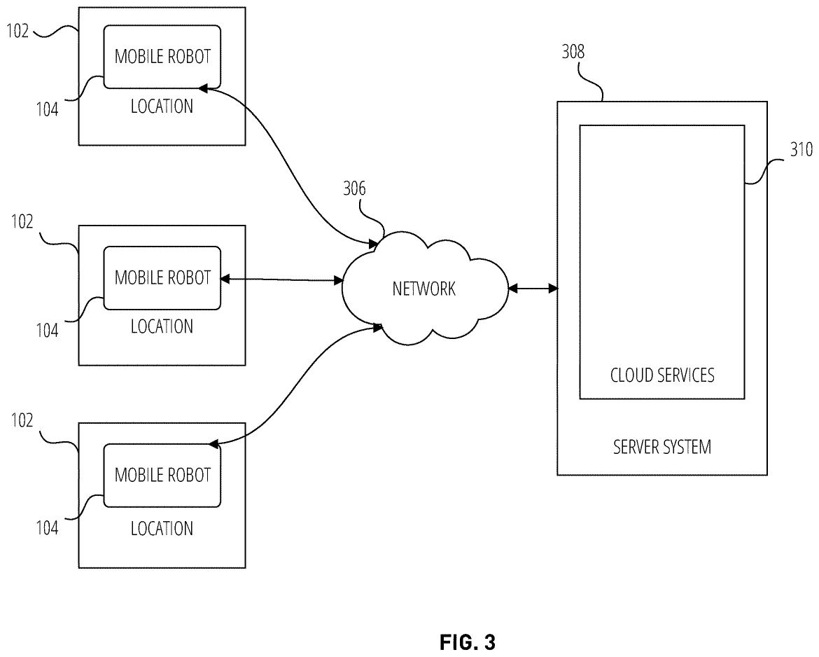

FIG. 3 is a diagrammatic representation of an environment in which multiple mobile robots 104 (e.g., a fleet of service robots) are deployed to respective locations 102 or environments, such as restaurants, hospitals, or senior care facilities, according to some examples. Depending on the location, the mobile robots 104 can perform any one of a number of functions within the location 102. Taking the example where these locations 102 are service locations such as restaurants, the mobile robots 104 can operate to assist with the delivery of items from a kitchen to tables within a particular restaurant, as well as the transportation of plates, trash, etc., from tables back to the kitchen. In another example where these locations 102 are medical locations such as hospitals, the mobile robots 104 can be deployed to perform functions such as, but not limited to, delivering medications to wards of the hospital, clearing waste from surgery rooms, and retrieving surgical instruments and supplies from supply closets. In yet another example, these locations 102 are senior care locations such as assisted living facilities, or a health care home for the elderly, the mobile robots 104 can be deployed to perform functions such as, but not limited to, retrieving items from storage closets and dispensing food or medication items. Each of the mobile robots 104 is communicatively coupled by a network 306, or multiple networks 306, to cloud services 310, which reside at one or more server systems 308. The mobile robots 104 can operate respective viewing windows 120 (as depicted in FIG. 1) based on a particular use case or based on a present location 102.

### Example Use Cases of a Mobile Delivery Device

For general deliveries, it is desired to show the contents to help advertise or display a capability or utility of the robot. This can demonstrate the utility of the mobile robot in its ability to perform various tasks.

For private packages and dirty loads, it is not desired for people to see what the robot is carrying. For example, if the robot is delivering medicine, legal/financial documents, dirty dishes or trash, the viewing window is rendered opaque.

In a medical setting, the mobile robot is used to makes deliveries where the location 102 is an elderly home. For deliveries such as courier packages, the viewing window is rendered transparent. For deliveries such as medicine from an on-site pharmacy, the viewing window is rendered opaque.

In a restaurant setting, when the robot is used as a running role, it can be desirable within a restaurant setting to advertise food but while securing delivery and maintaining sanitary presentation. Here, the mobile robot will render the viewing window transparent.

Also, in a restaurant setting, when the robot is used in a bussing role, it can be desirable within a restaurant to hide the bus tub with dirty dishes. Here, the mobile robot will render the viewing window opaque.

In a hotel setting, a mobile robot can include or use a plurality of containers (such as a plurality of containers 110 as depicted in FIG. 1). A single container 110 can include one or more partitions such as to define a plurality of compartments. In some examples, several customers in the hotel have called room service and asked for different items, such as extra towels or extra toiletries. Room service loads the items requested by different guests into different containers or compartments. Here, when the mobile robot arrives at a room the robot will make the smart film for the corresponding compartment transparent, and the other compartments opaque. Subsequently, the guest receives a notification that their item has arrived. The guest opens the door and sees their item in the robot's compartment. It will be clear to them why the robot is there, and which compartment to take from. Delivery using the selectively alterable viewing window can help a customer in receipt of items, since seeing their item in the robot's compartment can be more intuitive for customers than, e.g., messages or indicator lights.

Also, in a hotel setting, a mobile robot can be sent to deliver a package to a customer, such as a hotel guest. Before the robot opens the door, the robot turns on the smart film for that compartment and asks the customer to confirm the contents are what they ordered. This step confirms the package was placed in the correct compartment. Here, the guest is prevented from accessing the package before they check to confirm it is the correct package. This can also help ensure the guest only checks their respective robot compartment.

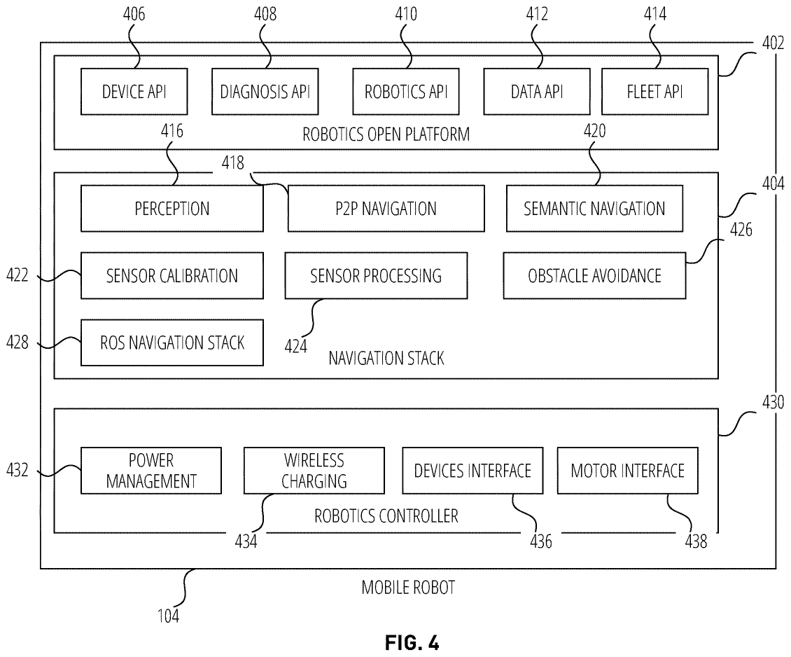

FIG. 4 is a block diagram illustrating one view of components and modules of a mobile robot 104, according to some examples. The mobile robot 104 includes a robotics open platform 402, a navigation stack 404, and a robotics controller 430. The robotics open platform 402 can provide one or more Application Program Interfaces (APIs), e.g., a device API 406, a diagnosis API 408, a robotics API 410, a data API 412, and a fleet API 414. The navigation stack 404 includes components that support, e.g., perception 416, P2P navigation 418, semantic navigation 420, sensor calibration 422, sensor processing 424, and obstacle avoidance 426. A Robot Operating Stack (ROS) navigation stack 428 also forms part of the navigation stack 404. The robotics controller 430 comprises components that support power management 432, wireless charging 434, devices interface 436, and motor control (or motor interface) 438.

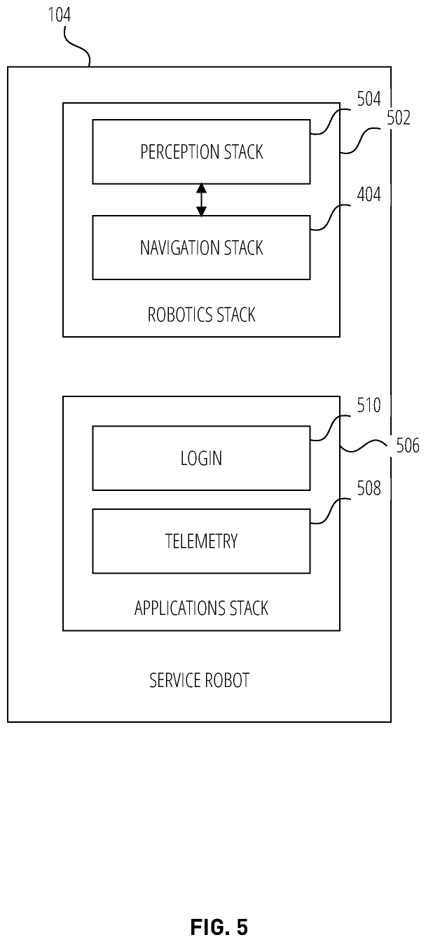

FIG. 5 is a block diagram illustrating another view of components and modules of a mobile robot 104, according to some examples. The mobile robot 104 includes a robotics stack 502 and an applications stack 506. The robotics stack 502, in turn, includes a perception stack 504 and a navigation stack 404. The applications stack 506 provides telemetry services 508 and login services 510 for the mobile robot 104.

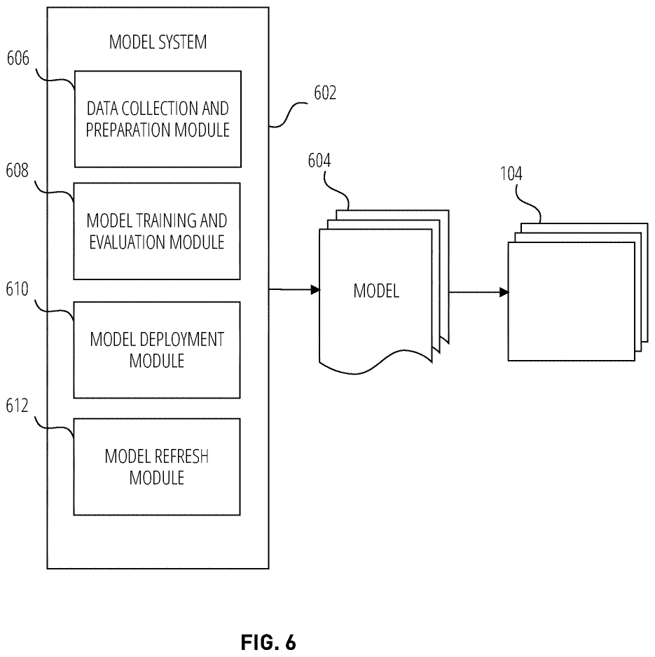

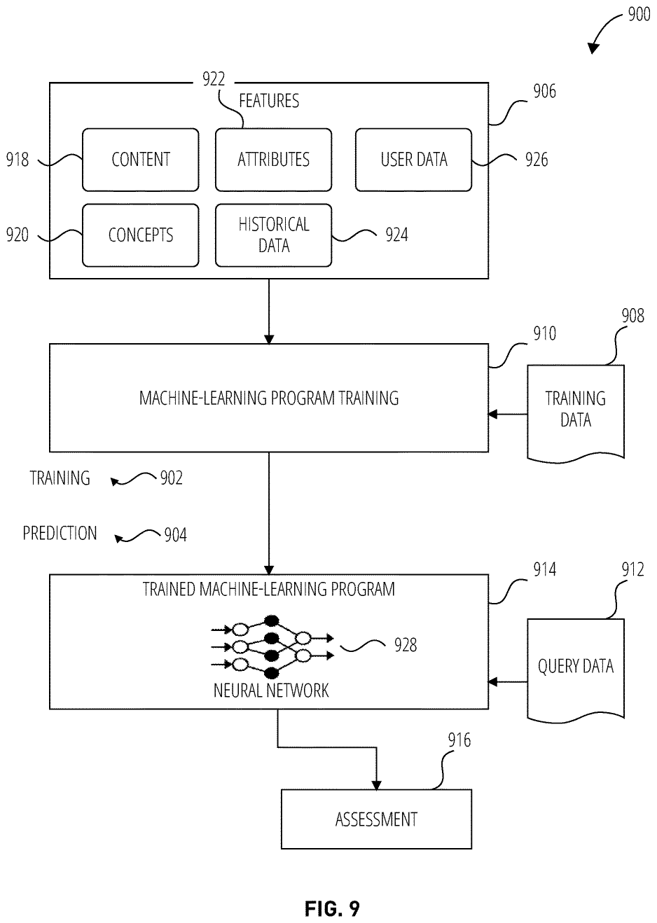

FIG. 6 is a block diagram showing a model system 602, according to some examples, that operates to create and maintain image localization models 604 that are deployed at various mobile robots 104 at one or more locations 102. The model system 602 can include one or more components or modules such as, e.g., data collection and preparation module 606, model training and evaluation module 608, model deployment module 610, or model refresh module 612. The models generated or deployed by the model system 602, such as the image localization models, can be machine learning (ML) models, generated for example by machine learning programs as described in FIG. 9.

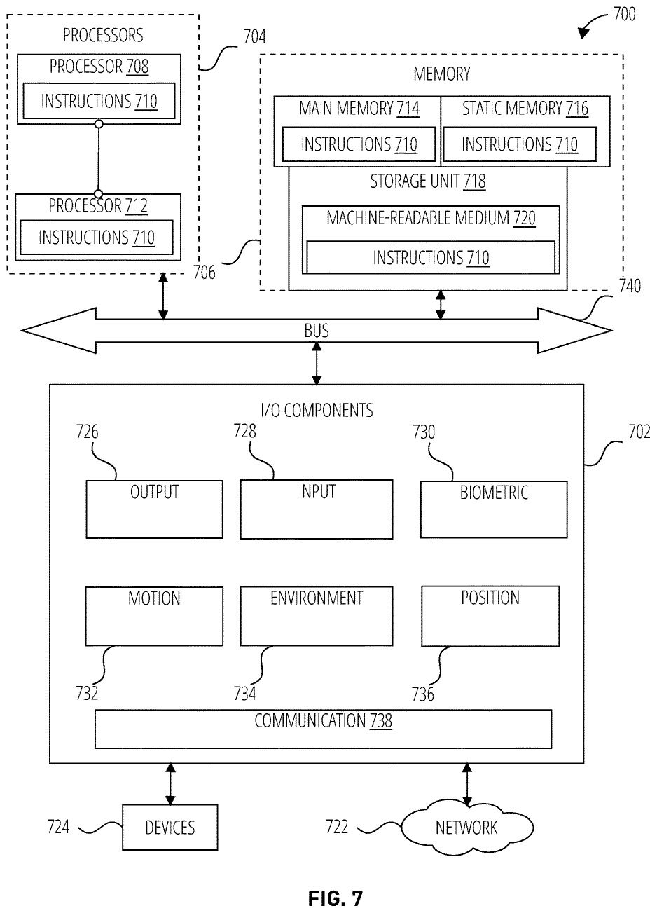

FIG. 7 is a diagrammatic representation of the machine 700, according to some examples, within which instructions 710 (e.g., software, a program, an application, an applet, an app, or other executable code) for causing the machine 700 to perform any one or more of the methodologies discussed herein can be executed. For example, the instructions 710 can cause the machine 700 to execute any one or more of the methods described herein. The instructions 710 transform the general, non-programmed machine 700 into a particular machine 700 programmed to carry out the described and illustrated functions in the manner described. The machine 700 can operate as a standalone device or be coupled (e.g., networked) to other machines. In a networked deployment, the machine 700 can operate in the capacity of a server machine or a client machine in a server-client network environment, or as a peer machine in a peer-to-peer (or distributed) network environment. The machine 700 can comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while a single machine 700 is illustrated, the term “machine” can include a collection of machines that individually or jointly execute the instructions 710 to perform any one or more of the methodologies discussed herein.

The machine 700 can include processors 704, memory 706, and I/O components 702, which can be configured to communicate via a bus 740. In some examples, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) can include, for example, a Processor 708 and a Processor 712 that execute the instructions 710. The term “Processor” is intended to include multi-core processors that can comprise two or more independent processors (sometimes referred to as “cores”) that can execute instructions contemporaneously. Although FIG. 7 shows multiple processors 704, the machine 700 can include a single processor with a single core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 706, the static memory 716, and storage unit 718 store the instructions 710 embodying any one or more of the methodologies or functions described herein. The instructions 710 can also reside, wholly or partially, within the main memory 714, within the static memory 716, within machine-readable medium 720, within the storage unit 718, within the processors 704 (e.g., within the processor's cache memory), or any suitable combination thereof, during execution thereof by the machine 700.

The I/O components 702 can include various components to receive input, provide output, produce output, transmit information, exchange information, or capture measurements. The specific I/O components 702 included in a particular machine depend on the type of machine. For example, portable machines such as mobile phones can include a touch input device or other such input mechanisms, while a headless server machine will likely not include such a touch input device. The I/O components 702 can include many other components not shown in FIG. 7. In various examples, the I/O components 702 can include output components 726 and input components 728. The output components 726 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 728 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 702 can include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 732 include acceleration sensor components (e.g., accelerometer), gravitation sensor components, rotation sensor components (e.g., gyroscope). The environmental components 734 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment. The position components 736 include location sensor components (e.g., a Global Positioning System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 702 further include communication components 738 operable to couple the machine 700 to a network 722 or devices 724 via respective coupling or connections. For example, the communication components 738 can include a network interface Component or another suitable device to interface with the network 722. In further examples, the communication components 738 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 724 can be another machine or any of a wide variety of peripheral devices (e.g., a peripheral device coupled via a USB).

Moreover, the communication components 738 can detect identifiers or include components operable to detect identifiers. For example, the communication components 738 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information can be derived via the communication components 738, such as location via Internet Protocol (IP) geolocation, location via Wi-Fi® signal triangulation, or location via detecting an NFC beacon signal that can indicate a particular location.

The various memories (e.g., main memory 714, static memory 716, and/or memory of the processors 704) and/or storage unit 718 can store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 can be transmitted or received over the network 722, using a transmission medium, via a network interface device (e.g., a network interface component included in the communication components 738) and using any one of several well-known transfer protocols (e.g., hypertext transfer protocol (HTTP)). Similarly, the instructions 710 can be transmitted or received using a transmission medium via a coupling (e.g., a peer-to-peer coupling) to the devices 724.

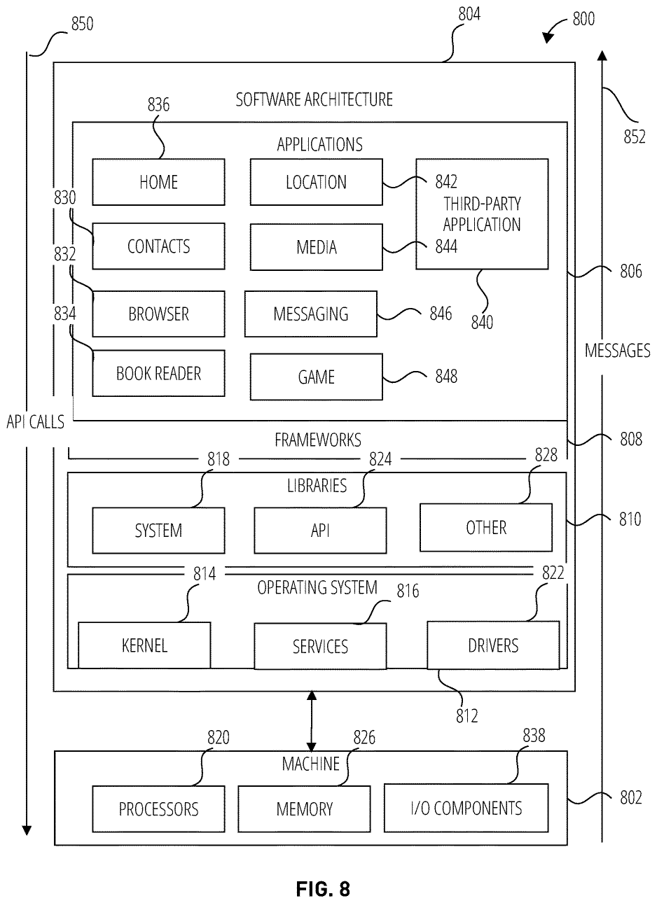

FIG. 8 is a block diagram 800 illustrating a software architecture 804, which can be installed on any one or more of the devices described herein. The software architecture 804 is supported by hardware such as a machine 802 that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, Processor management (e.g., scheduling), component management, networking, and security settings, among other functionalities. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 810 provide a low-level common infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.164 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 810 can also include a wide variety of other libraries 828 to provide many other APIs to the applications 806.

The frameworks 808 provide a high-level common infrastructure used by the applications 806. For example, the frameworks 808 provide various graphical user interface (GUI) functions, high-level resource management, and high-level location services. The frameworks 808 can provide a broad spectrum of other APIs that can be used by the applications 806, some of which can be specific to a particular operating system or platform.

In some examples, the applications 806 can include a home application 836, a contacts application 830, a browser application 832, a book reader application 834, a location application 842, a media application 844, a messaging application 846, a game application 848, and a broad assortment of other applications such as a third-party application 840. Applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) can be mobile software running on a mobile operating system such as IOST, ANDROID™, WINDOWS® Phone, or another mobile operating system. In this example, the third-party application 840 can invoke the API calls 850 provided by the operating system 812 to facilitate functionality described herein.

FIG. 9 is a block diagram showing a machine-learning program 900, according to some examples. The machine-learning programs 900, also referred to as machine-learning algorithms or tools, are used as part of the systems described herein to perform operations associated with image localization, searches, query responses and more.

Machine learning is a field of study that gives computers the ability to learn without being explicitly programmed. Machine learning explores the study and construction of algorithms, also referred to herein as tools, that can learn from or be trained using existing data and make predictions about or based on new data. Such machine-learning tools operate by building a model from example training data 908 in order to make data-driven predictions or decisions expressed as outputs or assessments (e.g., assessment 916). Although examples are presented with respect to a few machine-learning tools, the principles presented herein can be applied to other machine-learning tools.

In some examples, different machine-learning tools can be used. For example, Logistic Regression (LR), Naive-Bayes, Random Forest (RF), neural networks (NN), matrix factorization, and Support Vector Machines (SVM) tools can be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 900 supports two types of phases, namely a training phases 902 and prediction phases 904. In training phases 902, supervised learning, unsupervised or reinforcement learning can be used. For example, the machine-learning program 900 (1) receives features 906 (e.g., as structured or labeled data in supervised learning) and/or (2) identifies features 906 (e.g., unstructured or unlabeled data for unsupervised learning) in training data 908. In prediction phases 904, the machine-learning program 900 uses the features 906 for analyzing query data 912 to generate outcomes or predictions, as examples of an assessment 916.

In the training phase 902, feature engineering is used to identify features 906 and can include identifying informative, discriminating, and independent features for the effective operation of the machine-learning program 900 in pattern recognition, classification, and regression. In some examples, the training data 908 includes labeled data, which is known data for pre-identified features 906 and one or more outcomes. Each of the features 906 can be a variable or attribute, such as individual measurable property of a process, article, system, or phenomenon represented by a data set (e.g., the training data 908). Features 906 can also be of several types, such as numeric features, strings, and graphs, and can include one or more of content 918, concepts 920, attributes 922, historical data 924 and/or user data 926, merely for example.

In training phases 902, the machine-learning program 900 uses the training data 908 to find correlations among the features 906 that affect a predicted outcome or assessment 916.

With the training data 908 and the identified features 906, the machine-learning program 900 is trained during the training phase 902 at machine-learning program training 910. The machine-learning program 900 appraises values of the features 906 as they correlate to the training data 908. The result of the training is the trained machine-learning program 914 (e.g., a trained or learned model).

Further, the training phases 902 can involve machine learning, in which the training data 908 is structured (e.g., labeled during preprocessing operations), and the trained machine-learning program 914 implements a simple neural network 928 capable of performing, for example, classification and clustering operations. In other examples, the training phase 902 can involve deep learning, in which the training data 908 is unstructured, and the trained machine-learning program 914 implements a deep neural network 928 that is able to perform both feature extraction and classification/clustering operations.

A neural network 928 generated during the training phase 902 and implemented within the trained machine-learning program 914, can include a hierarchical (e.g., layered) organization of neurons. For example, neurons (or nodes) can be arranged hierarchically into a number of layers, including an input layer, an output layer, and multiple hidden layers. The layers within the neural network 928 can have one or many neurons, and the neurons operationally compute a small function (e.g., activation function). For example, if an activation function generates a result that transgresses a particular threshold, an output can be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 928 can also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 904, the trained machine-learning program 914 is used to perform an assessment. Query data 912 is provided as an input to the trained machine-learning program 914, and the trained machine-learning program 914 generates the assessment 916 as output, responsive to receipt of the query data 912.

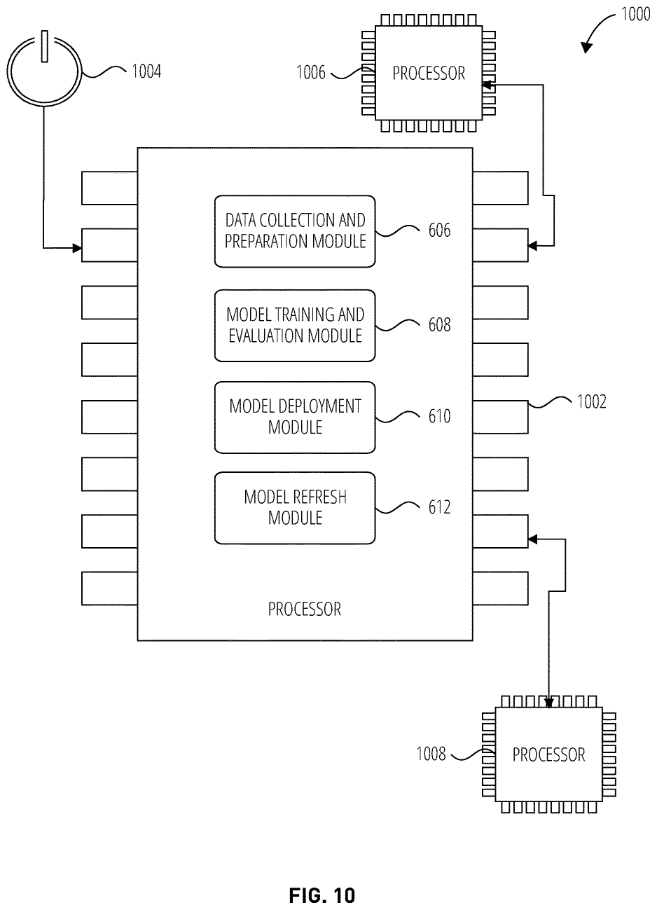

Turning now to FIG. 10, a diagrammatic representation of a processing environment 1000 is shown, which includes a processor 1002, a processor 1006 and a processor 1008 (e.g., a GPU, CPU, TPU or combination thereof).

The processor 1002 is shown to be coupled to a power source 1004, and to include (either permanently configured or temporarily instantiated) modules, namely a data collection and preparation module 606, a model training and evaluation module 608, a model deployment module 610, a model refresh module 612.

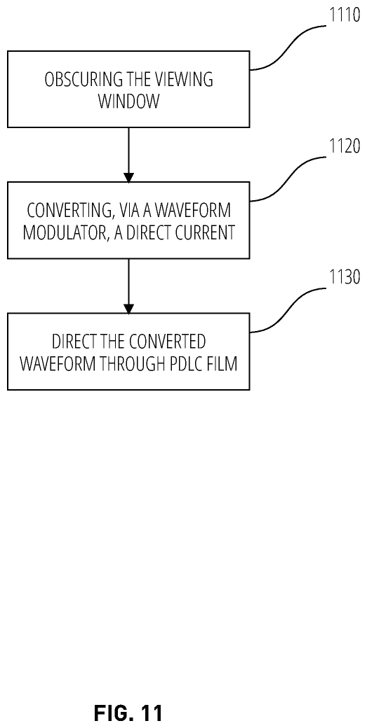

FIG. 11 is a flowchart that describes a method for operating a mobile robot 104, according to some examples. In some examples, at operation 1110, the method can include obscuring the viewing window of the robot via a polymer dispersed liquid crystal (PDLC) film in a first, non-energized state. At operation 1120, the method can include converting, via a waveform modulator, a direct current (DC) waveform from a battery onboard the mobile delivery robot to a periodic current waveform. For example, such converting can be performed via an oscillator (such as to convert the DC waveform to a PDC waveform) or an inverter (such as to convert the DC waveform to an AC waveform). At operation 1130, the method can include directing the periodic current waveform through at least one conductive layer of the PDLC film to transition the PDLC film to a second, energized state that renders the viewing window at least partially transparent. Such directing of the periodic current waveform through the at least one conductive layer of the PDLC can cause displaying, via the viewing window, the deliverable item within the receptacle. Also, the method can include impeding the periodic current waveform from the at least one conductive layer of the PDLC film to revert or maintain the PDLC film to the first, non-energized state. In example, obscuring or displaying can be performed based on the obtained location coordinates. For example, the method can include determining an intended destination type of the mobile delivery robot. The method can also include, based on the intended destination type, initiating a process to render the viewing window at least partially transparent. In some examples, the method can include carrying, via a drive train of the mobile delivery robot, the deliverable item to the intended destination.

In some examples, the method can include authenticating a user, such as following a transition of the PDLC film to the second, energized state. Similar authentication can occur preceding the transition of the PDLC film to the second, energized state, and such a transition can occur conditionally upon the authentication. For instance, the method can include transmitting the access code to an intended recipient user account associated with the user. For example, the method can include generating the access code corresponding to the intended recipient user account prior to transmission. Authenticating can also include receiving, via a user interface of the mobile delivery robot, an access code. Also, upon authentication of the intended recipient user account, a door of the mobile delivery robot can be opened such as to permit access to the receptacle to an authenticated recipient.

Similar methods of authentication can also be performed conditionally upon determining that the mobile delivery robot is within a specified radius of an intended destination. Also, based upon determining that the mobile delivery robot is within the specified radius of the intended destination, a process can be initiated to render the viewing window at least partially transparent. This can help visually present an enclosed item to an intended recipient upon arrival of the mobile robot without physically presenting the item and requiring verification of the intended recipient before physical presentation.

### Glossary

“Carrier Signal” refers to any intangible medium capable of storing, encoding, or carrying instructions for execution by the machine, and includes digital or analog communications signals or other intangible media to facilitate communication of such instructions. Instructions can be transmitted or received over a network using a transmission medium via a network interface device.

“Communication Network” refers to one or more portions of a network that can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner In examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processor. Once configured by such software, hardware components become specific machines (or specific components of a machine) tailored to perform the configured functions and are no longer general-purpose processors. A decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), the hardware components need not be configured or instantiated at any one instance in time. For example, where a hardware component comprises a general-purpose processor configured by software to become a special-purpose processor, the general-purpose processor can be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” refers to a hardware component implemented using one or more processors. Similarly, the methods described herein can be at least partially processor-implemented, with a particular processor or processors being some examples of hardware. For example, at least some of the operations of methods described herein can be performed by one or more processors 704 or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In some examples, the processors or processor-implemented components can be distributed across a number of geographic locations.

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-Storage Medium” refers to a single or multiple storage devices and/or media (e.g., a centralized or distributed database, and/or associated caches and servers) that store executable instructions, routines and/or data. The term includes solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium”, “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, some of which are covered under the term “signal medium.”

“Module” refers to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module can be a packaged functional hardware unit designed for use with other components and a part of a program that usually performs a particular function of related functions. Modules can constitute either software modules (e.g., code embodied on a machine-readable medium) or hardware modules. A “hardware module” is a tangible unit capable of performing certain operations and can be configured or arranged in a certain physical manner. In various examples, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein. In some examples, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC).

A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In examples in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information). The various operations of example methods and routines described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors. Similarly, the methods described herein can be at least partially processor-implemented, with a particular processor or processors being some examples of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an Application Program Interface (API)). The performance of certain of the operations can be distributed among the processors, not only residing within a single machine, but deployed across a number of machines. In some examples, the processors or processor-implemented modules can be located in a single geographic location (e.g., within a home environment, an office environment, or a server farm). In other examples, the processors or processor-implemented modules can be distributed across a number of geographic locations.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor can, for example, be a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC) or any combination thereof. A processor can further be a multi-core processor having two or more independent processors (sometimes referred to as “cores”) that can execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “signal medium” can include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and can be used interchangeably in this disclosure.

### Examples and Notes

The following, non-limiting examples, detail certain aspects of the present subject matter to solve the challenges and provide the benefits discussed herein, among others.

Example 1 is a method to operate a mobile robot, the mobile robot having a receptacle to receive a deliverable item and having a viewing window into the receptacle, the method comprising: obscuring the viewing window via a polymer dispersed liquid crystal (PDLC) film in a first, non-energized state; converting, via a waveform modulator, a direct current (DC) waveform from a battery onboard the mobile robot to a periodic current waveform; and directing the periodic current waveform through at least one conductive layer of the PDLC film to transition the PDLC film to a second, energized state that renders the viewing window at least partially transparent.

In Example 2, the subject matter of Example 1, wherein the waveform modulator includes an oscillator, and the periodic current waveform includes a pulsating direct current (PDC).

In Example 3, the subject matter of any of Examples 1-2, wherein the waveform modulator includes an inverter, and the periodic current waveform includes an alternating current (AC) waveform.

In Example 4, the subject matter of any of Examples 1-3, further comprising: authenticating, upon transition of the PDLC film to the second, energized state, an identity of a recipient of the deliverable item; and opening a door of the mobile robot to permit access to the receptacle to the authenticated recipient.

In Example 5, the subject matter of Example 4, wherein authenticating includes receiving, via a user interface of the mobile robot, an access code.

In Example 6, the subject matter of Example 5, further comprising transmitting the access code to an intended recipient user account.

In Example 7, the subject matter of any of Examples 1-6, further comprising generating an access code corresponding to an intended recipient user account.

In Example 8, the subject matter of any of Examples 1-7, further comprising: determining that the mobile robot is within a specified radius of an intended destination; and based on determining that the mobile robot is within the specified radius of the intended destination, initiating a process to render the viewing window at least partially transparent.

In Example 9, the subject matter of any of Examples 1-8, further comprising: determining an intended destination for delivery of the deliverable item; carrying, via a drive train of the mobile robot, the deliverable item to the intended destination; wherein displaying is performed upon the mobile robot arriving at the intended destination.

Example 10 is a mobile robot comprising: a container to enclose a deliverable item within the mobile robot; a viewing window to provide a view into the container, the viewing window including a polymer dispersed liquid crystal (PDLC) film actuatable to transition between: a first, non-energized state wherein the viewing window is opaque; and a second, energized state wherein the viewing window is transparent; a waveform modulator to convert a direct current (DC) waveform from a battery onboard the mobile robot to a periodic current waveform; and an actuator to direct the periodic current waveform through at least one conductive layer of the PDLC film to alter the PDLC film to the second, energized state.

In Example 11, the subject matter of Example 10, wherein the waveform modulator includes an oscillator, and the periodic current waveform includes a pulsating direct current (PDC).

In Example 12, the subject matter of any of Examples 10-11, wherein the waveform modulator includes an inverter, and the periodic current waveform includes an alternating current (AC) waveform.

In Example 13, the subject matter of any of Examples 10-12, further comprising: authenticator circuitry to identify a recipient of the deliverable item upon transition of the PDLC film to the second, energized state; wherein the authenticator circuitry is communicatively coupled to a door of the mobile robot, the mobile robot to operate the door upon authentication of an authenticated recipient.

In Example 14, the subject matter of Example 13, wherein the authenticator circuitry is communicatively coupled to a user interface to receive an access code.

In Example 15, the subject matter of Example 14, further comprising transceiver circuitry for transmitting the access code to an intended recipient user account.

In Example 16, the subject matter of any of Examples 10-15, further comprising: location circuitry to determine that the mobile robot is within a specified radius of an intended destination; and a waveform controller communicatively coupled to the location circuitry to render the viewing window at least partially transparent based on determining that the mobile robot is within the specified radius of the intended destination.

In Example 17, the subject matter of any of Examples 10-16, further comprising: a drive train to move the robot towards an intended destination; transceiver circuitry to receive coordinates corresponding to an intended destination for delivery of a deliverable item; and wherein the actuator includes a waveform controller communicatively coupled to location circuitry to direct the periodic current waveform through the at least one conductive layer of the PDLC film upon the mobile robot arriving at the intended destination.

Example 18 is a method to operate a mobile robot, the mobile robot having a receptacle to receive a deliverable item and having a viewing window into the receptacle, the method comprising: obscuring a deliverable item via a display panel that is selectively operable to display or obscure a view of the deliverable item within the receptacle without opening the receptacle; obtaining mobile robot location coordinates; and displaying a view of the deliverable item via operation of the display panel via an electric signal communicatively coupled with the display panel, wherein the displaying is performed based on the obtained location coordinates matching delivery coordinates.

Example 19 is a method to operate a mobile robot, the mobile robot having a receptacle to receive a deliverable item and having a viewing window into the receptacle, the method comprising: obscuring the viewing window via a polymer dispersed liquid crystal (PDLC) film in a first, non-energized state; converting, via a waveform modulator, a direct current (DC) waveform from a battery onboard the mobile robot to a periodic current waveform; directing the periodic current waveform through at least one conductive layer of the PDLC film to transition the PDLC film to a second, energized state that renders the viewing window at least partially transparent; determining an intended destination type of an intended destination of the mobile robot; and based on the intended destination type, initiating a process to render the viewing window at least partially transparent.

In Example 20, the subject matter of Example 19, wherein the waveform modulator includes an oscillator, and the periodic current waveform includes a pulsating direct current (PDC).

In Example 21, the subject matter of any of Examples 19-20, wherein the waveform modulator includes an inverter, and the periodic current waveform includes an alternating current (AC) waveform.

In Example 22, the subject matter of any of Examples 19-21, further comprising: authenticating, upon transition of the PDLC film to the second, energized state, an identity of a recipient of the deliverable item; and opening a door of the mobile robot to permit access to the receptacle to the authenticated recipient.

In Example 23, the subject matter of Example 22, wherein authenticating includes receiving, via a user interface of the mobile robot, an access code.

In Example 24, the subject matter of Example 23, further comprising transmitting the access code to an intended recipient user account.

In Example 25, the subject matter of any of Examples 19-24, further comprising generating an access code corresponding to the intended recipient user account.

In Example 26, the subject matter of any of Examples 19-25, further comprising carrying, via a drive train of the mobile robot, the deliverable item to the intended destination.

Example 27 is a mobile robot comprising: a container to enclose a deliverable item within the mobile robot; and a viewing window to provide a view into the container, the viewing window being operable between two states including a first state wherein the viewing window is opaque and a second state wherein the viewing window is transparent.

Example 28 is at least one machine-readable medium including instructions that, when executed by processing circuitry, cause the processing circuitry to perform operations to implement of any of Examples 1-27.

Example 29 is an apparatus comprising means to implement any of Examples 1-27.

Example 30 is a system to implement any of Examples 1-27.

Example 31 is a method to implement any of Examples 1-27.

The above Detailed Description can include references to the accompanying drawings, which form a part of the detailed description. The drawings show, by way of illustration, specific examples in which the invention can be practiced. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples, with each claim standing on its own as a separate example, and it is contemplated that such examples can be combined with each other in various combinations or permutations. The scope of the invention should be determined with reference to the appended claims, along with the full scope of equivalents to which such claims are entitled.

1. A method to operate a mobile robot, the mobile robot having a receptacle to receive a deliverable item and having a viewing window into the receptacle, the method comprising:
obscuring the viewing window via a polymer dispersed liquid crystal (PDLC) film in a first, non-energized state;
converting, via a waveform modulator, a direct current (DC) waveform from a battery onboard the mobile robot to a periodic current waveform; and
directing the periodic current waveform through at least one conductive layer of the PDLC film to transition the PDLC film to a second, energized state that renders the viewing window at least partially transparent.

2. The method of claim 1, wherein the waveform modulator includes an oscillator, and the periodic current waveform includes a pulsating direct current (PDC).

3. The method of claim 1, wherein the waveform modulator includes an inverter, and the periodic current waveform includes an alternating current (AC) waveform.

4. The method of claim 1, further comprising:
authenticating, upon transition of the PDLC film to the second, energized state, an identity of a recipient of the deliverable item; and
opening a door of the mobile robot to permit access to the receptacle to the authenticated recipient.

5. The method of claim 4, wherein authenticating includes receiving, via a user interface of the mobile robot, an access code.

6. The method of claim 5, further comprising transmitting the access code to an intended recipient user account.

7. The method of claim 1, further comprising generating an access code corresponding to an intended recipient user account.

8. The method of claim 1, further comprising:
determining that the mobile robot is within a specified radius of an intended destination, and
based on determining that the mobile robot is within the specified radius of the intended destination, initiating a process to render the viewing window at least partially transparent.

9. The method of claim 1, further comprising:
determining an intended destination for delivery of the deliverable item; and
carrying, via a drive train of the mobile robot, the deliverable item to the intended destination;
wherein displaying is performed upon the mobile robot arriving at the intended destination.

10. A mobile robot comprising:
a container to enclose a deliverable item within the mobile robot;
a viewing window to provide a view into the container, the viewing window including a polymer dispersed liquid crystal (PDLC) film actuatable to transition between:
a first, non-energized state wherein the viewing window is opaque; and
a second, energized state wherein the viewing window is transparent;
a waveform modulator to convert a direct current (DC) waveform from a battery onboard the mobile robot to a periodic current waveform; and
an actuator to direct the periodic current waveform through at least one conductive layer of the PDLC film to alter the PDLC film to the second, energized state.

11. The mobile robot of claim 10, wherein the waveform modulator includes an oscillator, and the periodic current waveform includes a pulsating direct current (PDC).

12. The mobile robot of claim 10, wherein the waveform modulator includes an inverter, and the periodic current waveform includes an alternating current (AC) waveform.

13. The mobile robot of claim 10, further comprising:
authenticator circuitry to identify a recipient of the deliverable item upon transition of the PDLC film to the second, energized state;
wherein the authenticator circuitry is communicatively coupled to a door of the mobile robot, the mobile robot to operate the door upon authentication of an authenticated recipient.

14. The mobile robot of claim 13, wherein the authenticator circuitry is communicatively coupled to a user interface to receive an access code.

15. The mobile robot of claim 14, further comprising transceiver circuitry for transmitting the access code to an intended recipient user account.

16. The mobile robot of claim 10, further comprising:
location circuitry to determine that the mobile robot is within a specified radius of an intended destination, and
a waveform controller communicatively coupled to the location circuitry to render the viewing window at least partially transparent based on determining that the mobile robot is within the specified radius of the intended destination.

17. The mobile robot of claim 10, further comprising:
a drive train to move the robot towards an intended destination; and
transceiver circuitry to receive coordinates corresponding to an intended destination for delivery of a deliverable item, and
wherein the actuator includes a waveform controller communicatively coupled to location circuitry to direct the periodic current waveform through the at least one conductive layer of the PDLC film upon the mobile robot arriving at the intended destination.

18. A method to operate a mobile robot, the mobile robot having a receptacle to receive a deliverable item and having a viewing window into the receptacle, the method comprising:
obscuring a deliverable item via a display panel that is selectively operable to display or obscure a view of the deliverable item within the receptacle without opening the receptacle;
obtaining mobile robot location coordinates; and
displaying a view of the deliverable item via operation of the display panel via an electric signal communicatively coupled with the display panel, wherein the displaying is performed based on the obtained location coordinates matching delivery coordinates.

19. A method to operate a mobile robot, the mobile robot having a receptacle to receive a deliverable item and having a viewing window into the receptacle, the method comprising:
obscuring the viewing window via a polymer dispersed liquid crystal (PDLC) film in a first, non-energized state;
converting, via a waveform modulator, a direct current (DC) waveform from a battery onboard the mobile robot to a periodic current waveform;
directing the periodic current waveform through at least one conductive layer of the PDLC film to transition the PDLC film to a second, energized state that renders the viewing window at least partially transparent;
determining an intended destination type of an intended destination of the mobile robot; and
based on the intended destination type, initiating a process to render the viewing window at least partially transparent.

20. The method of claim 19, wherein the waveform modulator includes an oscillator, and the periodic current waveform includes a pulsating direct current (PDC).

21. The method of claim 19, wherein the waveform modulator includes an inverter, and the periodic current waveform includes an alternating current (AC) waveform.

22. The method of claim 19, further comprising:
authenticating, upon transition of the PDLC film to the second, energized state, an identity of a recipient of the deliverable item, and
opening a door of the mobile robot to permit access to the receptacle to the authenticated recipient.

23. The method of claim 22, wherein authenticating includes receiving, via a user interface of the mobile robot, an access code.

24. The method of claim 23, further comprising transmitting the access code to an intended recipient user account.

25. The method of claim 24, further comprising generating an access code corresponding to the intended recipient user account.

26. The method of claim 19, further comprising
carrying, via a drive train of the mobile robot, the deliverable item to the intended destination.

27. A mobile robot comprising:
a container to enclose a deliverable item within the mobile robot; and
a viewing window to provide a view into the container, the viewing window being operable between two states including a first state wherein the viewing window is opaque and a second state wherein the viewing window is transparent.
